(19) United States
(12) Patent Application Publication
(10) Pub. No.: US 2017/0277806 A1
(43) Pub. Date: Sep. 28, 2017

(54) PROCEDURES FOR CONTENT AWARE CACHING AND RADIO RESOURCE MANAGEMENT FOR MULTI-POINT COORDINATED TRANSMISSION

(71) Applicant: INTERDIGITAL PATENT HOLDINGS, INC., Wilmington, DE (US)

(72) Inventors: Dirk Trossen, London (GB); Onur Sahin, London (GB)

(73) Assignee: INTERDIGITAL PATENT HOLDINGS, INC., Wilmington, DE (US)

(21) Appl. No.: 15/514,235

(22) PCT Filed: Sep. 23, 2015
(86) PCT No.: PCT/US2015/051707

§ 371 Date: Mar. 24, 2017

Related U.S. Application Data
(60) Provisional application No. 62/055,216, filed on Sep. 25, 2014.
(60) Provisional application No. 62/154,271, filed on Apr. 29, 2015.

(51) Int. Cl. G06F 17/30; H04L 29/08

(52) U.S. Cl. CPC G06F 17/30902; H04L 67/2842; H04W 4/18

(57) ABSTRACT

A method and network access point (NAP) capable of serving content to a requesting wireless transmit/receive unit (WTRU). The NAP receives a request for content from the WTRU via an air interface associated with the NAP. The requested content is associated with an allowable latency. The NAP determines whether the requested content is cached locally at the NAP. On a condition that the requested content is not cached locally at the NAP, the NAP determines delay metrics associated with obtaining the requested content from a centralized cache and at least one neighboring NAP. The NAP selects the centralized cache or the at least one neighboring NAP to retrieve the requested content from based on the delay metrics and the allowable latency associated with the requested content. The NAP then transmits the requested content to the WTRU over the air interface.

### CROSS REFERENCE TO RELATED APPLICATIONS

This application is the U.S. National Stage, under 35 U.S.C. §371, of International Application No. PCT/US2015/051707 filed Sep. 23, 2015, which claims the benefit of U.S. Provisional Application No. 62/055,216, filed Sep. 25, 2014, and U.S. Provisional Application No. 62/154,271, filed Apr. 29, 2015, the contents of which are hereby incorporated by reference herein.

### BACKGROUND

Content delivery networks (CDNs) have been used to accelerate the retrieval of web content, including images and videos, in order to reduce latency experienced by end users. Current CDN deployments employ relatively large centralized storage elements to which content requests are re-directed when a user makes a request, for example, through a hypertext transfer protocol (HTTP)-based request.

### SUMMARY

A method and network access point (NAP) capable of serving content to a requesting wireless transmit/receive unit (WTRU). The NAP receives a request for content from the WTRU via an air interface associated with the NAP. The requested content is associated with an allowable latency. The NAP determines whether the requested content is cached locally at the NAP. On a condition that the requested content is not cached locally at the NAP, the NAP determines delay metrics associated with obtaining the requested content from a centralized cache and at least one neighboring NAP. The NAP selects the centralized cache or the at least one neighboring NAP to retrieve the requested content from based on the delay metrics and the allowable latency associated with the requested content. The NAP then transmits the requested content to the WTRU over the air interface.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a diagram of the system components and interactions of a first embodiment;

FIG. 3 is a diagram of system components with example delays at a plurality of network attachment points (NAPs);

FIG. 4 is a diagram of system components depicting the latency incurred between the centralized manager, NAPs, and WTRU for content request and response; and

FIG. 5 is a diagram of signaling procedures for content based CoMP clustering and transmission.

### DETAILED DESCRIPTION

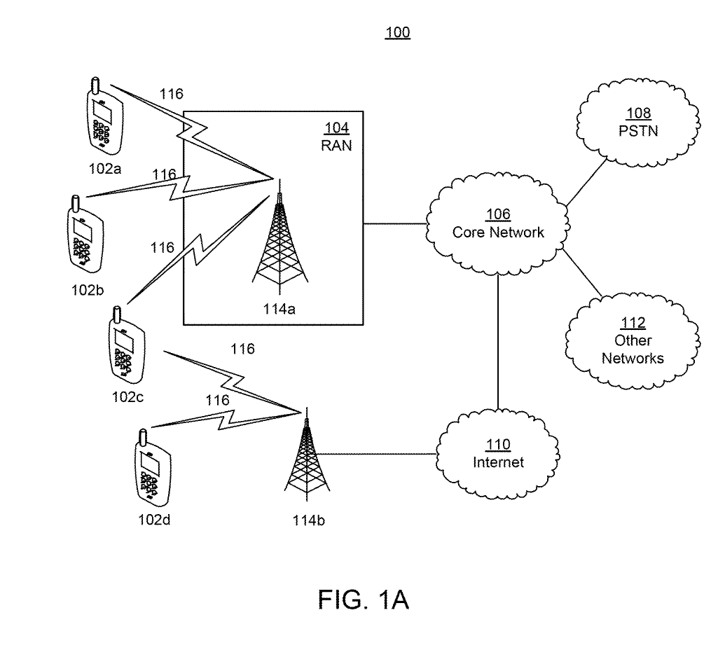

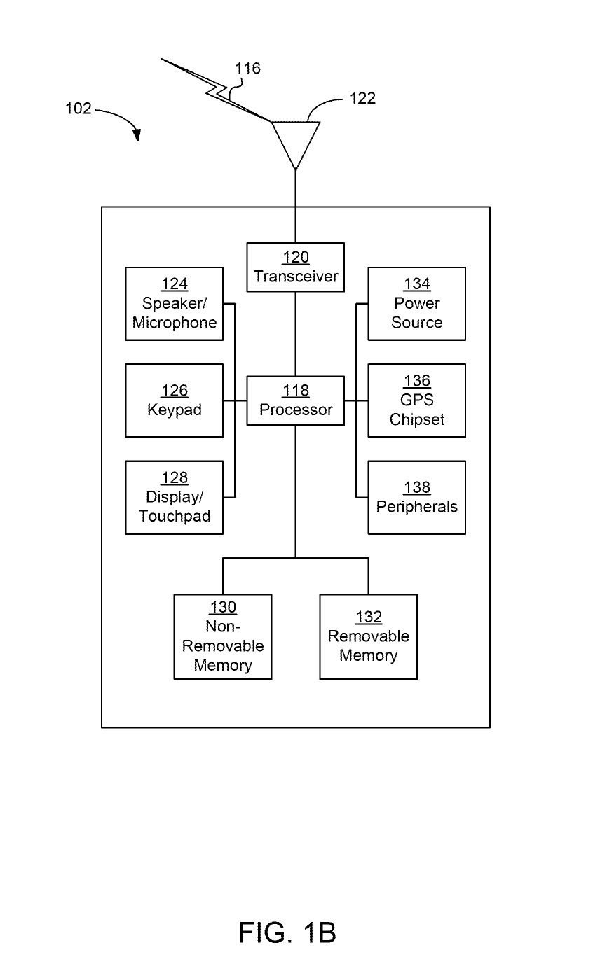

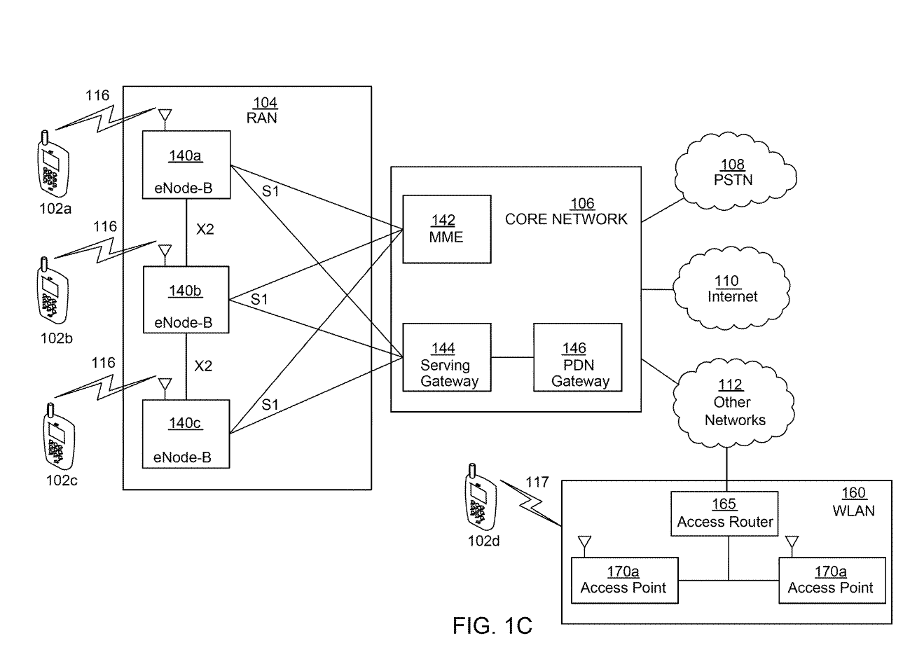

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the Si interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Other network 112 may further be connected to an IEEE 802.11 based wireless local area network (WLAN) 160. The WLAN 160 may include an access router 165. The access router may contain gateway functionality. The access router 165 may be in communication with at least one of a plurality of access points (APs) 170a, 170b. The communication between access router 165 and APs 170a, 170b may be via wired Ethernet (IEEE 802.3 standards), or any type of wireless communication protocol. AP 170a is in wireless communication over an IEEE 802.11 based air interface 117 with WTRU 102d. WTRU 102d may be a dual mode device capable of communicating with both LTE RAN 104 and WLAN 160, as well as other networks operating according to other respective air interface protocols.

Enabling caching of relevant content under a calculated latency constraint metric that considers the delays incurred during the retrieval of the content is described herein. The delays incurred may be associated with delay associated with retrieving the content from either a centralized storage, neighboring cells, or other content storage area. Methods for requesting content from a centralized cache management controller in order to avoid violations of latency constraints are also described. Methods to request content from neighboring network attachment points (NAPs) in order to avoid violations of latency constraints are also described. New protocols and system domain architectures within a network and interface descriptions between the domains to enable, collate, share and process content retrieval requests are also described. Methods and procedures to enable content aware coordinated multi-point transmission in an access network by forming a distributed or centralized NAP clustering based on the available content in the NAP caches, where the clustering request and feedback messages are updated with the content related information (for example, a content ID) are also described. Methods for NAP clustering based on the cache content probability and NAP selection and feedback procedures to statistically minimize air link latency are also described. Methods and procedures to dynamically reconfigure virtual radio functions (VRF) at the network nodes in accordance with cache content; assign particular VRFs at the nodes to minimize the forwarding delay of a particular content class (for example, video codec functionality for video dominated caching at a node); and allocate sufficient link capacity between the nodes to forward the VRF outputs are also described. Methods and procedures for NAP to WTRU access link radio resource allocation via distributed caching hand-shaking between NAPs are also described.

Enabling immersive experiences through low latency content delivery and maximizing the efficiency of the air interface under the latency constraint towards the end user are enabled by the methods, architectures, and procedures described herein. For example, on a tourist bus in London, the upper deck may be filled with tourists from various countries, wearing augmented reality glasses as part of their tour. When passing sites, such as the Tower Bridge, the tourists may be presented with audio-visual material, for example, small movie snippets of past events, or overlays of historical photos, in their respective native language. Moreover, content may vary based on the age of the tourist, thereby providing age appropriate content to individual tourists. In another example, at a football game, in a critical moment, after an offensive player has been tackled by the opposite side's defender, a particular spectator may decide to have a closer look at this scene—from a different angle that is chosen through a local speech input to that particular spectator's immersive, augmented reality glass wear. This is achieved by taking advantage of the views shared by many other spectators in the stadium.

In the examples described above, and in numerous other real world scenarios, caching content closer to the end user may reduce service-level latency. Edge gateway solutions for mobile networks are one way to reduce service-level latency. Edge gateways store content previously retrieved for the served region in an attempt to improve latency for future requests. When pushing content storage closer to the user, the logical next step is to cache content right at the NAP (i.e., a base station of a mobile cellular network or a WiFi access point) by enhancing each NAP with appropriate storage functionality. However, it is likely that the storage capabilities of such enhanced NAPs would be relatively small in relation to the likely large content that could be retrieved within the cell that the NAP is serving. Therefore, edge network caching solutions may employ regionally centralized intelligence that coordinates the management of the content within the region, while the content itself is stored in a distributed fashion across the individual enhanced NAPs. The role of centralized intelligence is to coordinate content storage amongst the NAPs, and to determine popular or long-lived content that may be disseminated to a particular NAP or a particular set of NAPs, for example, to minimize the likelihood of violating latency constraints that are associated with the consumption of the particular content.

The centralized intelligence may also make decisions in cases where content is request from one or more distributed NAP caches and those NAP caches do not have the requested content. This situation is referred to herein as a cache entry miss. Moreover, the centralized intelligence will maximize the efficiency of the local air interface from the NAP towards the end user during these cache entry misses.

In such a system, when the NAP experiences a local cache entry miss (i.e. the content requested by an end user is not available in the NAP's local cache) the NAP may make a localized decision for requesting content from the centralized content management system or from direct NAP neighbors. This decision will consider the trade off in caching content locally with the constraint of fulfilling the user's content request within a defined latency threshold. The threshold may be defined through service level agreements.

This system may allow such latency constraints to be fulfilled by taking into account the incurred delays for retrieving data from the centralized cache management system or from (often closer) NAP neighbors.

The system extends cached content retrieval by relying on a hybrid of distributed cache storage and centralized fallback storage, extending the content retrieval decisions with those aiming at fulfilling a given latency threshold. Cached content retrieval requests may be issued to nearby NAP caches that might store the requested content rather than a more distant centralized storage.

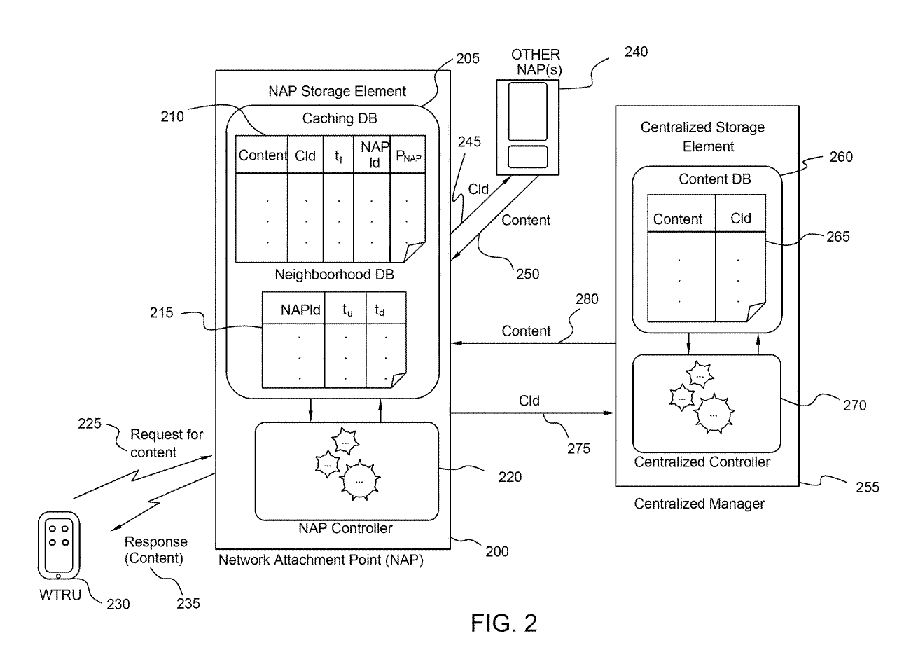

FIG. 2 is a diagram of the system components and interactions of a first embodiment of the above described system. Referring to FIG. 2, a NAP 200 includes a NAP storage element 205. The NAP storage element 205 may be a volatile memory, a hard disk drive, or it may be a cloud based storage system, for example. The NAP storage element 205 may include a caching database 210. The caching database 210 may be a data structure stored in the NAP storage element 205, and may include the following columns: content, unique content identifiers (CId), unique NAP identifiers (NAPIds), a latency threshold tₗ, and a probability P_{NAP}. These columns are exemplary and are not meant to be limiting or required columns in the caching database 210. The content column includes content items according to application layer specific semantics, for example, encoded pictures, text, video, web pages, sound files, and the like. The CId column includes CId, each of which is associated with one entry of the caching database 210. In one embodiment, the CId may be a URL to a web-based resource, while in another embodiment, the CId may be hashed entries (these hashes being computed over naming schemes such as URLs). The latency threshold tₗ column includes a latency threshold tₗ parameter associated with a particular content ID. The probability _{P}NAP column includes a p_{NAP} parameter indicating the probability that the neighbor indicated by the NAPId stores the content item identified by CId.

Continuing to refer to FIG. 2, the NAP storage element 205 may also include a neighborhood database 215. The neighborhood database 215 may be a data structure stored in the NAP storage element 205, and may include a column for unique NAP identifiers of NAPs to be contacted for content retrieval. The neighborhood database 215 may also include a column for a delay threshold of an uplink (tᵤ) connection to a respective NAP and of a downlink (t_{d}) connection to a respective NAP, for each NAPId.

Continuing to refer to FIG. 2, the NAP 200 may also include a NAP controller 220. The NAP controller 220 may receive a request for content 225 from a WTRU 230, identified through a CId, and subsequently check whether or not the requested content resides in the caching database 210 of the NAP 200. If the requested content resides in the caching database 210, the NAP controller 220 may deliver a response 235 to the WTRU 230 including the requested content. The NAP controller 220 may also send content items based on requests received from other NAPs 240. The NAP controller 220 may also send a content retrieval request 245 to other NAPs 240. The content retrieval request 245 sent from the NAP 200 to other NAPs 240 may include a CId associated with particular content, when a cache miss occurs at the NAP 200. In other words, when the NAP 200 receives a request for content 225 requesting content that is not stored in the caching database 210 of the NAP 200, the NAP controller 220 may send a content retrieval request 245 to other NAPs 240 in order to obtain the content in the request for content 225. At least one other NAP 240 may respond with the requested content 250. While other NAPs 240 is referenced herein as plural, the NAP 200 and the NAP controller 220 may communicate with a single other NAP 240 in some embodiments.

Continuing to refer to FIG. 2, a centralized manager 255 includes a centralized storage element 260 that includes a content database 265 that may include a content column for content items according to application specific semantics, for example, encoded pictures, text, video, web pages, sound files, and the like. The content database 265 may be a volatile memory, a hard disk drive, or it may be a cloud based storage system, for example. The content database 265 may also include a column for unique content identifiers, CId, each of which may be associated with one entry of content stored in the content database 265. The centralized manager 255 may also include a centralized controller 270.

The NAP controller 220 of NAP 200 may send content retrieval requests 275 for particular content identifiers CIds to the centralized manager 255 in case of a cache miss at the NAP 200. The centralized controller 270 may receive and process a content retrieval request 275 for particular content identified by a specific CId. The centralized controller may provide the requested content 280 to a requesting NAP or a set of NAPs in a multipoint manner.

The entries stored in the caching database 210 and the content database 265, for example, the entries for the NAPid and the pNAP for a specific CId, may be obtained by various methods. Cache entry synchronization among the various NAPs 200, 240 that are served by the central manager 255 may also be performed. The content database 265 of the centralized manager 255 may also be populated using various methods. For example, the content database 265 may be pre-seeded, for example, by publishing specific content towards the centralized manager 255.

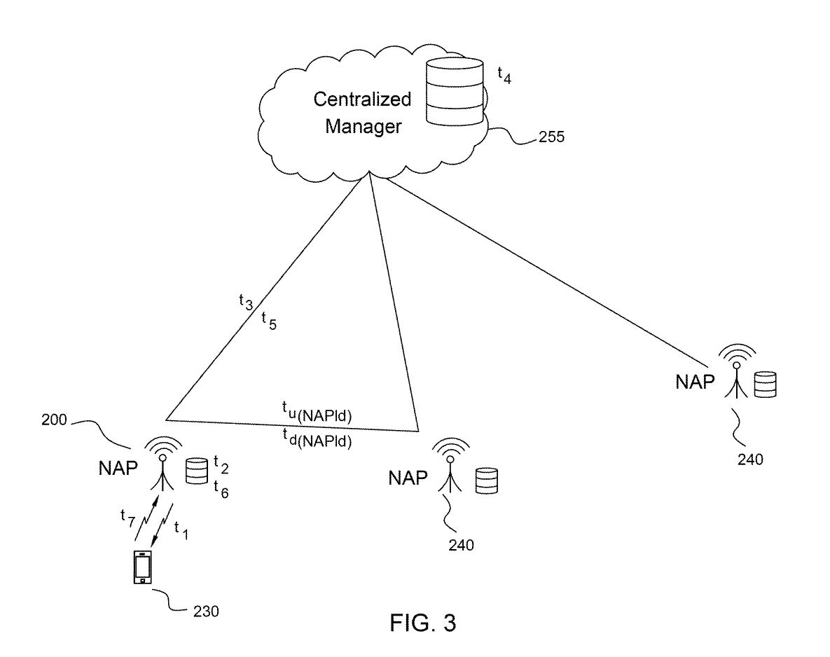

FIG. 3 is a diagram of system components with example delays at each component. The system is similar to the system described above with reference to FIG. 2, and like elements are referred to using like reference numerals. Delay t₁ may represent the time required to send a request for content over an air interface from WTRU 230 to NAP 200. This delay be determined via frequent measurements of air interface transmissions, using, for example, a sliding window or weighted averaging technique for incorporating variations of recent air interface conditions into a calculated delay parameter t₁.

Delay t₂ may represent the time to process a request for content at the NAP 200. This time may include the extraction of the content from the local caching database of the NAP 200, and preparation for sending the requested content to the WTRU 230 via the air interface. This delay may be determined by estimating the processing delay, which may be affected by, for example, NAP processor speed, content size, and network interface processing delay. This delay may be measured frequently through internal time stamping or may be estimated through heuristics.

Delay t₃ may represent the time to send a content request over a backhaul link to the centralized manager 255, in the case where the requested content is not available at the NAP 200 (i.e., a local cache miss). This delay may be determined through frequent measurements of the backhaul transmissions and may be a function of the size of the content transmitted over the backhaul link. The delay may be averaged using, for example, a sliding window or weighted averaging mechanism.

Delay t₄ may represent the time to process an incoming content request at the centralized manager 255. This time may include the extraction of the content from the content database of the centralized manager 255, and preparation for sending the requested content to the NAP 200 via the backhaul link. This delay may be determined by estimating the processing delay, which may be affected by, for example, the centralized manager processor speed, content size, and network interface processing delay. This delay may be measured frequently through internal time stamping or may be estimated through heuristics.

Delay t₅ may represent the time to send the content over the backhaul link from the centralized manager 255 to the NAP 200. This delay may be determined through frequent measurements of the backhaul transmissions and may be a function of the size of the content transmitted over the backhaul link. The delay may be averaged using, for example, a sliding window or weighted averaging mechanism.

Delay t₆ may represent the time required to prepare the transmission of requested content over the air interface from the NAP 200 to the WTRU 230. This delay may be determined by estimating the processing delay of the NAP 200, which may be affected by, for example, processor speed, content size, and network interface processing delay. This delay may be measured frequently through internal time stamping or estimated through heuristics.

Delay t₇ may represent the time delay in sending the content over the air interface from the NAP 200 to the WTRU 230. This delay may be determined via frequent measurements of the air interface transmissions, using, for example, a sliding window or weighted averaging technique for incorporating variations of recent air interface conditions into the delay.

Delay t_{tu(NAPId)} may represent the time required to send a content request from NAP 200 to the other NAP 240 via an inter-NAP link. The content request from NAP 200 may be based on a NAPid stored in the NAP 200. This delay may be determined through frequent measurements of transmissions between NAP 200 and the other NAP 240 with a given NAPid. This delay may be a function of the size of the content transmitted. The delay may be averaged using, for example, a sliding window or weighted averaging mechanism.

Delay t_{td(NAPId)} may represent the time required to send the requested content from the other NAP 240 to the NAP 200 in response to the content request. This delay may be determined through frequent measurements of transmissions from the other NAP 240 with the given NAPid. This delay may be a function of the size of the content transmitted. The delay may be averaged using, for example, a sliding window or weighted averaging mechanism.

From the delays described above, all delays with the exception of delay t₄ may be measured by the NAP 200 where the delay metrics may be used. In order to convey the delay metric t₄ to the NAP 200, standard network-level reporting from the centralized manager 255 to the NAP may be used (for example, using the simple network management protocol (SNMP) to access a management information base (MIB) via query and response mechanisms).

The service-level latency associated with a particular content is defined as t_{l(CId)}. In the case when content requested by WTRU 230 exists locally at the NAP 200 in the cache database, the content may be directly served back to the WTRU 230, incurring minimal service-level latency.

Upon receiving a request for content at the NAP 200 from the WTRU 230, the NAP 200 may perform the following steps. If the acceptable service-level latency associated with the requested content is larger than the total delay for retrieving content from the centralized manager 255, i.e., t_{u(CId)}>t₁+t₂+t₃+t₄+t₅+t₆+t₇, and the NAP 200 determines that the requested content is not stored locally in its cache database, the NAP 200 may request the content from the centralized manager 255.

In one embodiment, the acceptable service-level latency may be determined through content classification, where the result of a deep packet inspection (DPI) on the content will be mapped to determined acceptable latencies for that type of content. For example, certain types of video content will have a first acceptable latency, whereas photographic content may have a second acceptable latency. In another embodiment, the acceptable service-level latency may be signaled either as part of the content request (for example, as metadata included in the request) or out-of-band through additional signaling procedures.

If the acceptable service-level latency associated with the requested content is smaller than the total delay for retrieving the content from the centralized manager 255, i.e., t_{l(CId)}>t₁+t₂+t₃+t₄+t₅+t₆+t₇, retrieving the requested content from the centralized manager 255 may violate the acceptable service-level latency constraint. Therefore, the NAP 200 may determine at least one other NAP 240 from which the requested content may be retrieved without a guaranteed violation of the acceptable service-level latency. The following different policies may be used to achieve this, either alone or in various combinations.

In a first example, a first come first served approach may be implemented. The NAP 200 may determine the first other NAP 240 from its neighborhood database where the delay for requesting the requested content to the other NAP t_{u(NAPId)} combined with the delay for the other NAP to provide the requested content t_{d(NAPId)} is less than the acceptable service-level latency of the requested content (i.e. t_{u(CId)}>t_{u(NAPId)}+t_{d(NAPId)}). When this condition is met, the NAP 200 may request the content from the first other NAP 240 that satisfies this condition.

In a second example, a best serve approach is implemented. The NAP 200 may determine a delay for requesting the requested content to the other NAP t_{u(NAPId)} combined with the delay for the other NAP to provide the requested content t_{d(NAPId)} for each of the other NAPs in the neighborhood database of the NAP 200. The various calculated delays are compared and the NAPid with the smallest delay may be selected. If this selected minimum delay is smaller than t_{l(CId)}, the NAP 200 may send a content request to the other NAP 240 corresponding to the selected NAPid. This strategy may or may not consider the probability that the selected other NAP actually has the requested content cached.

In a third example, a best serve conservative approach is implemented. The NAP 200 may determine a delay for requesting the requested content to the other NAP t_{u(NAPId)} combined with the delay for the other NAP to provide the requested content t_{d(NAPId)} for each of the other NAPs in the neighborhood database of the NAP 200. The various calculated delays are compared and the NAPid with the smallest delay may be selected. If this selected minimum delay is smaller than t_{l(CId)}, the NAP 200 may send a content request to the other NAP 240 corresponding to the selected NAPid. Further, the NAP 200 may determine, for other NAPs that may satisfy the acceptable service-level latency, the other NAP with the highest individual probability of having the requested content (i.e. the highest pNAP value). This strategy may meet the acceptable service-level latency constraint with the highest probability possible for actually retrieving the requested content from the selected other NAP.

If no other NAP 240 can be found for which the acceptable service-level latency can be satisfied, the NAP 200 may implement one or more of the following policies.

In a first example, the NAP 200 may implement an always use centralized manager approach. In the case of a cache miss at the NAP 200 (i.e. the content requested by the WTRU 230 is not stored locally at the NAP 200) the content request may be forwarded to the centralized manager 255 for retrieval of the content. In a second example, the NAP 200 may use a minimal delay violation approach. In the case of a cache miss at the NAP 200 (i.e. the content requested by the WTRU 230 is not stored locally at the NAP 200) the content request may be forwarded to either one of the other NAPs 240 or the centralized manager 255, and the selection for which entity to forward the content request to is based on whichever entity minimizes the delay in obtaining the requested content.

The NAP 200 may implement a policy that controls whether content received from either the centralized manager 255 or other NAPs 240 is stored locally at the NAP 200 for future content requests. The NAP 200, as described with reference to FIG. 2, may include a caching database 210. A NAP controller 220 of the NAP 200 may implement the policy, and store content received from either the centralized controller 255 or other NAPs 240 in the caching database 210.

In another embodiment, the NAP 200 may implement a policy that minimizes content retrieval delay on the backhaul portion of the network (i.e. between the NAP 200, the other NAPs 240, and the centralized manager 255), aiming to maximize the remaining delay budget at the NAP 200. In another embodiment, the air interference delay may be optimized. Constraining the cache request decisions by the acceptable service-level latency threshold may allow for maximizing the final delay t₇ (i.e., the delay associated with sending the requested content from the NAP 200 to the WTRU 230 over the air interface.) Upon making the decision for retrieval either from the centralized manager 255 or from a neighboring other NAP 240, following the methods described herein, the NAP 200 may re-configure the air interface at the physical layer as well as the media access control (MAC) layer, to fulfill the remaining delay budget (which is larger or equal to t₇, if all the aforementioned decisions have been met correctly). In other words, the requested content may be obtained from a network cache selected to maximize the available downlink air interface delay t₇. The re-configuration of the air interface may include methods for changing the modulation scheme, the transmission power, the encoding scheme, the MAC-level buffer management (for example, by changing priorities or QoS metrics), and the like. For each change to the air interface parameters, the NAP 200 may calculate a resulting delay t_{7′}, ensuring that t_{7′}<t₇ (i.e., any change of air interface parameters will not violate the allowable delay budget utilized in the content retrieval). The allowable delay budget may be communicated from the NAP 200 to the various NAP elements, including the NAP controller 220, ensuring the appropriate reconfiguration of the air interface. Extensions to Network Function Virtualization (NFV) for placing radio control functionality (including the NAP controller 220) as application-like functions in the NAP 200 may be used to communicate the delay budget via methods for inter-application or inter-hypervisor communication between the virtualized network functions that are being executed at the NAP 200 with the help of such extended NFV framework.

Methods and procedures for coordinated edge caching and air-interface configuration procedures will now be described. A WTRU may request content with content id CId from the NAP which it is associated with (which may be a Third Generation Partnership Project (3GPP) Long Term Evolution (LTE) evolved Node B (eNB)). The example focuses on the case where either the NAP does not have the requested content in its cache database, or the retrieval time of the content along with the latency incurred in the wireless link violates the allowable latency requirement of the content requested by the WTRU. This example scenario is not intended to be limiting, and is only for explanation purposes, as other cases and scenarios may also be handled by the methods and procedures described.

In such a case, the WTRU requests content (for example, video frames, speech packets, delay-tolerant data packets, and the like) via an uplink channel (for example the Physical Uplink Shared Channel (PUSCH) in LTE systems). The PUSCH may be updated to include media content identifier bits. On a condition that the associated NAP does not have the requested content available in its local cache database, in one option, it may proceed with the methods and procedures described above, considering that (1) the content request is made from the centralized controller to satisfy the latency requirements; (2) the associated NAP identifies the neighbor other NAPs by selecting those that satisfy the latency requirements; and (3) if neither the centralized controller, nor the neighbor other NAPs guarantee the latency requirements, then the NAP may proceed with selecting the ones that incur minimal latency for content retrieval. The statistical information that denotes the content availability at the neighbor other NAPs may also be included in the content retrieval decision making.

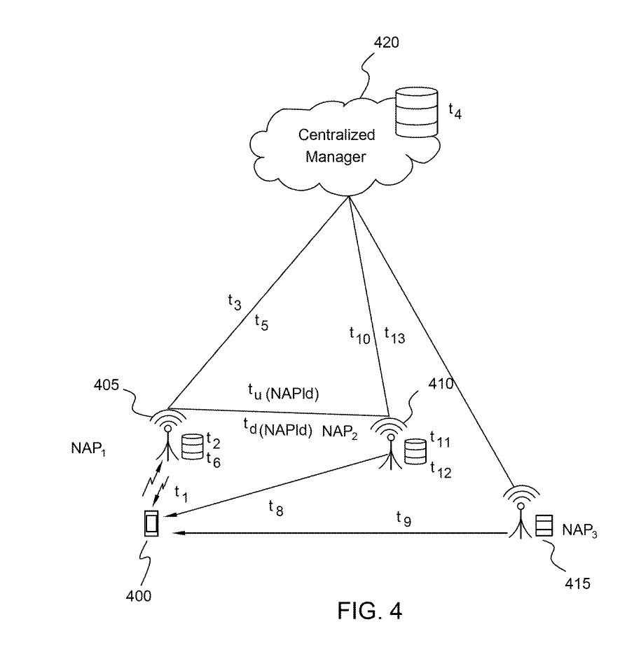

In FIG. 4, a WTRU 400 is associated with a first NAP₁ 405. The system also includes two neighboring NAPs, NAP₂ 410 and NAP₃ 415, as well as a centralized manager 420. WTRU 400 transmits a content request to associated NAP₁ 405. In one example, when there is a cache miss at NAP₁ 405 (in other words, when NAP₁ 405 does not have the requested content stored locally in its cache database) NAP₁ 405 identifies that the content retrieval latency, either from the centralized manager 420 or any neighboring NAP (i.e., NAP₁ 405, NAP₂ 410, or NAP₃ 415), does not satisfy the allowable service level latency (for example, t_{l(CId)}>t₁+t₂+t₃+t₄+t₅+t₆, t_{l(CId)}<t_{u(NAPId)}+t_{u(NAPId)}). In this case, NAP clustering may be utilized. The delays and related parameters, as shown and referenced in FIG. 4, may be defined as follows.

Delays t₁, t₈, t₉ may represent the time required to communicate over the air interface between the WTRU 400 and NAP₁ 405, NAP₂ 410 2, and NAP₃ 415, respectively. These delays may be determined via frequent measurements of the air interface transmissions, using, for example, a sliding window or weighted averaging technique for incorporating variations of recent air interface conditions into the delay. These delays will likely be a function of the amount of data required to be communicated, and uplink delays from the WTRU 400 may differ from downlink delays to WTRU 400.

Delays t₂, t₁₁ may represent the time required to process a content request, determine whether the requested content is locally cached in a caching database of the NAP, extract the content from the local cache, and prepare for sending back the retrieved content via the air interface, at NAP1 400 and NAP₂ 405, respectively. This may be determined by estimating the processing delays depending on processor speed, content size and network interface processing delay, which may be measured frequently through internal timestamping or estimated through heuristics.

Delays t₃, t₁₀ may represent the time required to send a content request over the backhaul links from NAP₁ 405 and NAP₂ 410, respectively, to the centralized manager 420. This may be determined through frequent measurements of the backhaul transmissions, and these delays may be a function of the size of the content transmitted. The delay may be averaged using, for example, a sliding window or weighted averaging mechanism.

Delay t₄ may represent the time required to process an incoming content request at the centralized manager 420, and process and prepare the content for sending back to the requesting NAP. This may be determined by estimating the processing depending on processor speed, content size and network interface processing delay. This may be measured frequently through internal timestamping or estimated through heuristics.

Delays t₅, t₁₃ may represent the time required to send the retrieved content over the backhaul link from the centralized manager 420 to NAP₁ 405 and NAP₂ 410, respectively. This may be determined through frequent measurements of the backhaul transmissions in dependence of the size of the content transmitted. The delay might be averaged using, for example, a sliding window or weighted averaging mechanism.

Delays t₆, t₁₂ may represent the time required to prepare the sending of the content over the air interface at NAP₁ 405 and NAP₂ 410, respectively. This may be determined by estimating the processing delay depending on processor speed, content size and network interface processing delay. This may be measured frequently through internal timestamping or estimated through heuristics.

Delay t_{u(NAPId)} may represent the time to send a content request over the link from NAP₁ 405 to a NAP associated with NAPId (in FIG. 4, NAP₂ 410, for example). This may be determined through frequent measurements of the transmissions towards the NAP with NAPid, and may be a function of the size of the content transmitted. The delay may be averaged using, for example, a sliding window or weighted averaging mechanism.

Delay t_{d(NAPId)} may represent the time to receive the content requested in a content request over the link from the NAP with NAPId (in FIG. 4, from NAP₂ 410 to NAP₁ 405). This may be determined through frequent measurements of the transmissions from NAP with NAPid, and may be a function of the size of the content transmitted. The delay may be averaged using, for example, a sliding window or weighted averaging mechanism.

The parameter t_{l(CId)} may represent the allowable service-level latency associated with a particular content CId.

Clustering that facilitates Coordinated Multipoint Transmission (CoMP) may increase the spectral efficiency and thus decrease the latency incurred over the air interface links. A coordinated content retrieval and air interface configuration method will now be described. It should be noted that the terms NAP and eNB are used interchangeably and denote the same meaning.

Continuing to refer to FIG. 4, NAP₁ 405 may identify a potential list of neighboring NAPs that may join the coordinated multi-point transmission to the WTRU 400 requesting content. The host NAP, NAP₁ 405, may identify the potential neighbor NAPs for CoMP transmission in a variety of ways. For example, NAP1 405 may use the location of the WTRU 400, for example, using global positioning system (GPS) coordinates included in management frames to determine appropriate neighboring NAPs for CoMP transmissions. NAP₁ 405 may use the eNB-WTRU attachment report, where the WTRU includes other eNBs the WTRU has carried out initial attachment procedures with, for example, cell-search hand-shaking, and the like. NAP₁ 405 may request the neighbor NAP information from the centralized manager which feeds back the potential eNB IDs for CoMP transmission.

In one embodiment, neighbor NAPs may provide an indicator to each other regarding which content they have stored locally in their respective caching databases. A NAP receiving this indicated may create a potential CoMP neighbor list knowing which NAPs have which content stored locally. Alternatively, the centralized manager may provide this indication to NAPs. In another option, a new information parameter may be defined which indicates both the probability of a NAP caching the requested content and additionally the delay incurred by this NAP to retrieve the requested content from its neighbor NAPs in case the NAP does not host the content itself.

Based on which method or methods are used, the NAP₁ 405 may transmit a CoMP clustering request message to its neighboring NAPs (i.e. NAP₂ 410 and NAP₃ 415) and/or the centralized manager 420. As discussed above, the node clustering request message may include information/classification bits about the requested content. The recipients of the node clustering request message may feedback handshaking or NACK messages to the NAP₁ 405. In one example, the recipients of the node clustering request message may also feedback identities of neighboring NAPs which might host the requested content. Also, the NAPs that accept the CoMP clustering request message may also include their transmit configuration parameters in an ACK feedback message sent to the NAP₁ 405. This information may be carried out either via direct NAP to NAP control and management frame signaling, or via the centralized manager 420.

With the potential NAPs for use in CoMP identified, the NAP₁ 405 (i.e. the host NAP) may calculate a new estimated air interface latency in the case of pairing with one or multiple of the identified neighbor NAPs cooperating in CoMP transmission to the WTRU 400 (i.e. NAP₂ 410 and NAP₃ 415). This new estimated air interface latency is denoted as t_{1CMP}. The number of NAPs selected for CoMP is not limited to two NAPs as shown, and may be as many NAPs as the underlying air interface technology supports. t_{1CMP} may be calculated from the transmit configuration parameters (for example, operating bandwidth, transmit power, number of antennas, and the like) of the NAPs that participate in the CoMP operation. Due to increases in the spectral efficiency, t_{1CMP}<min{t₁,t₈,t₉, . . . }. If the new air time link latency (t_{1CMP}) satisfies the latency requirement of the requested content (i.e. associated with CId), NAP₁ 405 may inform the selected neighboring NAPs that acknowledged the CoMP clustering request message regarding CoMP formation (i.e. NAP₂ 410 and NAP₃ 415). If the CoMP operation is not able to satisfy the latency requirement associated with CId, in one example, NAP₁ 405 may proceed with CoMP operation or inform the central manager 420 regarding the status.

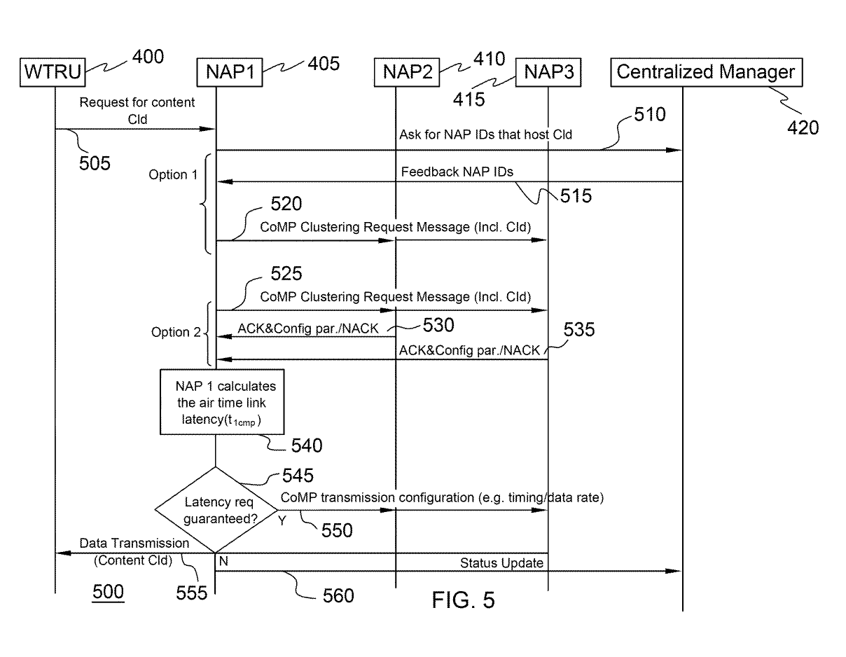

Referencing FIG. 5, signaling procedures 500 for content based CoMP clustering and transmission are shown. The reference numerals in FIG. 5 are consistent with those described in FIG. 4. WTRU 400 transmits a request for content CId to NAP₁ 405, step 505. In a first embodiment, as described above and labeled “Option 1” in FIG. 5, the host NAP₁ 405 requests NAP identifiers that are known to host the content associated with CId from the centralized manager 420, step 510. The centralized manager 420 responds with NAP identifiers of NAPs that are storing the content associated with CId, step 515. With the information supplied by the centralized manager 420, the host NAP₁ 405 then sends a CoMP Cluster Request Message to the NAPs that have been indicated as storing the content associated with CId, NAP₂ 410 and NAP₃ 415, step 520. The CoMP Clustering Request Message may include an indication of CId so that NAP₂ 410 and NAP₃ 415 may begin queuing the content associated with CId for transmission.

In a second embodiment, as described above and labeled “Option 2” in FIG. 5, the host NAP₁ 405, after receiving the request for content CId message from WTRU 400, sends CoMP Clustering Request Messages to neighboring NAPs NAP₂ 410 and NAP₃ 415, step 525. The CoMP Clustering Request Message may include CId to enable NAP₂ 410 and NAP₃ 415 to determine if the request content associated with CId is cached locally at each NAP. If the requested content is stored locally at the neighbor NAP, then the neighbor NAP may send an acknowledgment message (ACK) back to the host NAP₁ 405. If the requested content is not stored locally at the neighbor NAP, then the neighbor NAP may send a negative acknowledgment message (NACK) back to the host NAP₁ 405. In FIG. 5, NAP₂ 410 transmits an ACK/NACK message including the air interface configuration parameters (and optionally an indication of the air interface latency tₛ associated with NAP₂ 410) to the host NAP₁ 405, step 530. Similarly, NAP₃ 415 transmits an ACK/NACK message including the air interface configuration parameters (and optionally an indication of the air interface latency t₉ associated with NAP₃ 415) to the host NAP₁ 405, step 535.

Continuing to refer to FIG. 5, after both Option 1 and Option 2, the host NAP₁ 405 may calculate the air interface link latency t_{1CMP} as described above, step 540. If t_{1CMP} satisfies the allowable service level latency associated with the requested content, step 545, the host NAP₁ 405 sends CoMP transmission configuration information to the neighbor NAPs participating in the CoMP transmission, step 545. The CoMP transmission configuration information may include air interface parameters, for example, timing and data rate information. The neighbor NAPs participating in the CoMP transmission, i.e. NAP₂ 410 and NAP₃ 415, may then conduct CoMP data transmission to the WTRU 400 of the requested content associated with CId, step 555. If t_{1CMP} will not satisfy the allowable service level latency associated with the requested content, step 545, the host NAP₁ 405 may send a status update to the central manager 420, step 560.

In one example, the host NAP₁ 405 may only consider NAPs that already host the requested content for participation in CoMP transmissions.

In the embodiment described above, the host NAP₁ 405 may initially calculate the air-interface latency threshold for the requested content so as to meet the service level latency associated with the requested content. In this calculation, the host NAP₁ 405 includes both the centralized manager 420 and also neighbor NAPs (for example, NAP₂ 410 and NAP₃ 415) links for content retrieval. Thus, the necessary air-time link latency parameter is calculated as t_{AI}<t_{l(CID)}-min{t₁+t₂+t₃+t₄+t₅+t₆+t₇, t_{u(NAPId),i}+t_{d(NAPId),i}}, i=1,2,3, where i defines potential neighbor NAPs for content retrieval. With the maximum tai acceptable to satisfy the service-level latency, the host NAP₁ 405 may identify neighbor NAPs to be selected for the CoMP operation that yield acceptable t_{AI} performance. In order to identify the neighbor NAP set that would potentially satisfy the air interface timing requirement, in one option, each NAP may host a neighbor NAP information table with the entries containing at least: a NAP ID, an average/instantaneous air interface link capacity availability, an average latency in the air interface, and a content class identifier.

The host NAP₁ 405 information table may be updated periodically to yield the statistical information about the above described parameters. This may be achieved via periodically exchanging neighbor NAP information table management frames. In another option, updating this table at the host NAP₁ 405 may be triggered each time the CoMP clustering procedure is to be performed.

The above methods and procedures assume that the NAPs participating in the CoMP clustering host the requested content locally in their respective caching databases. In another case, where one or a plurality of neighbor NAPs do not have the requested content locally cached, those neighbor NAPs may feedback the necessary time they need to retrieve the content either from the centralized manager or their own neighbor NAPs. Referring back to FIG. 4, assuming that NAP₂ 410 does not have the requested content locally cached, NAP₂ 410 may calculate the content retrieval times from the centralized manager 420 and neighbor NAPs of NAP₂ 410, for example, min{t₁₀+t₁₃+t₁₁+t₁₂+t_{1CMP}+t₇, t_{u(NAPId),i}+t_{(NAPId),i}}, i=1,2,3. In one option, this information may be conveyed to the host NAP₁ 405, which may in turn be used by NAP₁ 405 to select which nodes to contact for CoMP operation.

In one example CoMP scenario, with continued reference to FIG. 4, NAP₂ 410 may host the requested content, Cⱼ, with probability pⱼ₂ and incurs latency of tⱼ₂. NAP₃ 415 may host the requested content with probability pⱼ₃, and incurs latency of tⱼ₃. In one embodiment, the host NAP₁ 405 may create a neighbor NAP list ordered by probability and may retrieve the content from all the NAPs that are above a given latency threshold tₛ, which is smaller than tₛ and constitutes the level of speculation of retrieving content from a neighbor NAP.

In another embodiment, the host NAP₁ 405 may create a neighbor NAP list ordered by latency may retrieve the content from all the NAPs that are above a given probability for retrieval threshold pₛ, which constitutes the level of speculation of retrieving content from a neighbor NAP.

The content probability information from the neighbor NAPs may be included in the neighbor NAP information table described above as a separate entry. The content probability values, as well as other parameters contained in the table, may be updated periodically by sending management frames to the neighbor NAPs, and the neighbor NAPs sending the feedback messages to update these parameters.

The host NAP₁ 405 employs an optimization procedure as follows: using the content probabilities, pj2, pj3, . . . pjN; latency incurred locally at the neighbor nodes, tj2, tj3, . . . , tjN; and access link capacities to the WTRU, R2WTRU, R3WTRU, . . . , RNWTRU, the host node calculates min {Pr (t_{AI}<t_{l(CID)})} such that CoMP id set=subset{2,3, . . . N}.

The output of the optimization at the host NAP₁ 405 may identify the minimum subset of candidate neighbor NAPs that will minimize the air interface delay, t_{AI}, statistically. Based on the output of this optimization, the host NAP₁ 405 may transmit a CoMP joint management message to the identified NAPs in the network. In case no such NAPs are identified, in one option, the host NAP₁ 405 may contact the central manager 420 to retrieve the requested content.

In order to exploit the CoMP multiplexing gain, in one example, for a particular content CId, the host NAP₁ 405 may request a unique, non-overlapping part of the content (for example, CId,_{partA}) from a neighboring NAP and another non-overlapping part from another neighboring NAP (for example, CId,_{partB}), which are already established as potential CoMP candidate NAPs via hand-shaking procedures described above. For example, NAP₁ 405 may transmit part of the compressed video content, for example, I frames, whereas NAP₂ 410 may transmit P frames. For this, content-specific functionality may need to be implemented in the NAP controller of host NAP₁ 405. In this method, the handshaking procedures may also include updated management frames where the host NAP₁ 405 may inform the neighbor NAPs, i.e. NAP₂ 410 and NAP₃ 415, which part of content is needed for CoMP operation (for example, Part A, Part B, etc.). With this information available, the NAPs may utilize multiplexed transmission at the air interface by efficiently allocating unique parts of the data to the WTRU 400. This can be achieved via distributed MIMO precoding operations such that each NAP multiplexes corresponding content into their transmit precoders and transmit in the downlink to the corresponding WTRU.

In another example, the NAPs may utilize network coding to improve reliability. The NAPs may send network-coded segments from each neighboring NAP to the requesting NAP. This diversification and redundancy of information provides benefits in resilience (for example, no acknowledgment messages may be required for individual retrieval in this scenario), potentially overall utilization, and distribution across NAPs (compared to single NAP retrieval).

Procedures to retrieve multi-layer coded content, e.g., MPEG DASH based, from individual NAPs may also be included. The selection of the appropriate NAP for individual layers may be driven in a delay-ordered manner, i.e., the most important (basic) layer is retrieved from the lowest delay NAP while the least significant layer is retrieved from the slowest NAP, ensuring that a basic quality is guaranteed with best delay.

Radio network function virtualization (RFV), for example, assigning functional splits of radio and link layers into various nodes in the network, has direct impact on various performance indicators such as latency incurred in the network. Moreover, efficient utilization and assignment of RFV is related to the content type, e.g., video, data packets, etc., transmitted in the network. The methods and procedures described herein jointly configure the radio function assignment in the network and content retrieval.

In the case that the host NAP₁ 405 does not have the requested content cached locally, it may compute the latency incurred by requesting content retrieval from the centralized manager 420 and the neighbor NAPs, NAP₂ 410 and NAP₃ 415. Based on the requested content class, for example, video, data, voice, streaming music, etc., the host NAP₁ 405 may contact the centralized manager 420 to jointly configure radio function assignments and content retrieval from NAP₂ 410 and NAP₃ 415 to the host NAP₁ 405. This may be triggered in the case that none of the possible neighbor NAPs or centralized manager 420 itself can satisfy the latency constraint required by the content. However, the methods and procedures described herein may also be case independent and pursued regularly to improve system performance.

In one example, the centralized manager 420 may also be responsible for managing the radio function assignment to different NAPs in the network. In another example, a separate coordinator entity may be responsible for procedures and interfaces with the centralized manager for the joint operation.

With the content retrieval request received, along with the content class and t_{l(CID)}, the centralized manager 420 may initially identify which NAPs, including itself, cache the content. Based on this information, the centralized manager 420 may perform functional assignments such that the service level latency is satisfied or the incurred latency is minimized. In one example, once the centralized manager 420 identifies the content host, it may assign compression functionality that is analog-to-digital (A/D) conversion sub-block to the host NAP, which transmits quantized information, for example, soft-bits, to the next hop identified in the content retrieval path. The content retrieval path may be determined by the centralized manager 420 which informs the corresponding NAPs in the network or by handshaking procedures between the NAPs themselves. Transmission of digitized signals by A/D conversion provides ultra-fast signal transmission, yet requires sufficient capacity between the host NAP and the next hop NAP on the content retrieval path. As a result, the centralized manager 420, with the information t_{l(CID)}, tᵢⱼ, and Cᵢⱼ, where i,j=1,2,3, . . . are the NAPs in the network, along with the content host NAP information, may assign A/D conversion sub-block accordingly.

The dynamic A/D conversion functionality allocation at the corresponding NAPs may be other virtual network/radio functionalities which are allocated by the centralized manager 420 based on particular key performance indicator (KPI) requirements. For instance, virtual radio function assignments may be performed in accordance with the caching of relevant content types. For example, for video, caching of the content and assignment of video codec functionalities to this NAP may be done in accordance, which shall result in overhead reduction as well as codec optimization.

In the case where the service latency constraint is not satisfied, or in the event that the host NAP₁ 405 identifies this condition, radio resource coordination between NAPs may be necessary. The methods and procedures described herein provide a coordination mechanism to guarantee service level latency from the host NAP₁ 405 to the requestor WTRU.

In one example, the host NAP₁ 405 identifies the neighbor NAPs it is sharing radio resources with. This may be determined via network control frames, or the measurement report received from the requestor WTRU, which may also include the NAP id that is detected using the same or proximate radio resources. Upon determining that the service level latency is not or cannot be satisfied, the host NAP₁ 405 may initiate a hand-shaking procedure with the neighbor NAPs that use the same radio resource pool. In one example, the serving NAP transmits a request, for example, a release resources message, to the neighbor NAPs in the same radio resource pool. The request to release resources message can also include an identification of the resources (for example, the bandwidth, the transmit time, the power, and the like) that is necessary to satisfy the service level latency to the requestor WTRU 400.

After receiving the request message from the host NAP₁ 405, the neighbor NAPs, depending on the status of their service level latency achievement performance, may or may not participate in configuring their access link resource usage. As such, from the perspective of neighbor NAP₂ 410 of FIG. 4, in case of t₈ being smaller than the necessary radio access latency, NAP₂ 410 may pursue reducing its bandwidth usage to the level sufficient to meet the required air-interface latency. NAP₂ 410 may then send an ACK message to host NAP₁ 405 to inform NAP₁ 405 of its release of the resource. The ACK message may include specific information related to the reconfigured resource, for example, the amount and location of frequency band released, the new transmission power level, and the like.

In an example embodiment using a cloud-based centralized manager hosted by a cloud provider, while the individual NAPs may be hosted by individual operators. The collection of NAPs may represent a geographical location (where different NAPs might belong to different operators covering a given location) or a temporal event (such as a sporting event or a music festival). The cloud-based centralized manager hosts the relevant content for these NAPs, while the methods described herein may be used to distribute the content to the users served by the NAPs. Third party cloud providers may implement location/event/organization-specific logic for the management of the content, while relying on the methods described herein to distribute the content. The third party cloud providers may charge for the management of the content on, for example, a service basis where the service may be the tourist experience in this example.

In an example embodiment, an operator-based centralized manager may be hosted by a single operator, serving exclusively NAPs deployed by that operator. In this example, content may be provided towards the centralized manager by, for example, organizers of local events, through operator-specific channels (such as publication interfaces), while the mechanisms described herein are used to distribute the content to the (operator-owned) NAPs. The operator may charge for optimal distribution of the content.

In an example embodiment, a facility-based centralized manager may be hosted by a facility owner, such as a manufacturing company or a shopping mall, in order to provide, for example, process-oriented content efficiently to the users of the facility. The NAPs of the content distribution system may be owned and deployed by the facility owner, with the centralized manager efficiently distributing the local content to the NAPs using the methods described herein. The facility owner or manufacturing company may charge for an experience that is associated with the facility, like the immersive experience within a theme park or museum. The facility owner may add an additional charge for an improved immersive experience, compared to a standard operator-based solution, relying on the methods described herein to distribute the content to the NAPs of the facility.

The methods described herein may be incorporated into relevant standards to ensure the interoperability between a centralized manager and NAPs of different vendors. However, the final deployment may also be entirely based on non-standard solutions, for example, in dedicated operator deployments. For these cases, the following methods may be used for monitoring.

Generally, the overall system of a centralized regional content manager and a set of NAPs under its control may be inferred from the individual deployment. Such an arrangement may serve as a first stage of monitoring.

Content retrieval in the methods described herein may be based on metadata referral, i.e., the NAP may provide a content ID, which is used to retrieve the actual content. With content IDs likely being of a constant length (or human-readable variable length names), such metadata-based approaches may be monitored in the system, with a final delivery of a variable sized content object. This may provide a second stage of monitoring.

The optimization of the retrieval process may be inferred by observing content retrieval requests. For this, a NAP may require placement in a controlled test environment where the nature of the delays depicted in FIG. 3 may be defined. Within such a test environment, creating specific content requests would likely lead to content retrieval requests towards particular NAPs that may serve the content within the desired latency constraint. Such a pattern of known retrieval points may be used in monitoring.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a network attachment point (NAP), the method comprising:
receiving a request for content from a wireless transmit/receive unit (WTRU) via an air interface, wherein the content is associated with an allowable latency;
determining whether the requested content is cached locally at the NAP, and on a condition that the requested content is not cached locally at the NAP:
determining delay metrics associated with obtaining the requested content from a centralized cache and at least one neighboring NAP;
determining probability metrics associated with the centralized cache and the at least one neighboring NAP, wherein the probability metrics indicate probabilities that the requested content is cached at the centralized cache or the at least one neighboring NAP; and
selecting the centralized cache or the at least one neighboring NAP to retrieve the requested content from based on the delay metrics, the probability metric, and the allowable latency; and
transmitting the requested content to the WTRU over the air interface.

2. The method of claim 1, further comprising:
caching the retrieved requested content at the NAP.

3. The method of claim 1, wherein the selecting the centralized cache or the at least one neighboring NAP is performed to minimize the delay metrics associated with obtaining the requested content.

4. (canceled)

5. The method of claim 1, further comprising:
communicating a message to the selected centralized cache or the at least one neighboring NAP, wherein the message includes a content identifier associated with the requested content; and
receiving the content associated with the content identifier from the selected centralized cache or the at least one neighboring NAP.

6. The method of claim 1, wherein one of the determined delay metrics is an air interface latency associated with transmitting and receiving information over the air interface, further comprising:
determining an interface latency budget based on the determined delay metrics; and
adjusting at least one air interface parameter to optimize the air interface latency.

7. The method of claim 6, wherein the at least one air interface parameter is at least one of a modulation and coding scheme (MCS), transmission power, error correction coding, or a quality of service parameter.

8. The method of claim 1, wherein the NAP selects at least one neighboring NAP to provide the requested content to the WTRU in a coordinated manner with the NAP.

9. The method of claim 8, further comprising:
receiving from the centralized cache or the selected at least one neighbor NAP a portion of the requested content; and
transmitting the portion of the requested content to the WTRU in a coordinated manner with the selected at least one neighbor NAP.

10. (canceled)

11. A network attachment point (NAP) comprising:
a receiver configured to receive a request for content from a wireless transmit/receive unit (WTRU) via an air interface, wherein the content is associated with an allowable latency;
a cache storage;
a processor configured to determine whether the requested content is cached locally at the NAP in the cache storage, and on a condition that the requested content is not cached locally at the NAP in the cache storage:
to determine delay metrics associated with obtaining the requested content from a centralized cache and at least one neighboring NAP;
to determine probability metrics associated with the centralized cache and the at least one neighboring NAP, wherein the probability metrics indicate probabilities that the requested content is cached at the centralized cache or the at least one neighboring NAP; and
to select the centralized cache or the at least one neighboring NAP to retrieve the requested content from based on the delay metrics, the probability metric, and the allowable latency; and
a transmitter configured to transmit the requested content to the WTRU over the air interface.

12. The NAP of claim 11, wherein the cache storage is configured to cache the retrieved requested content.

13. The NAP of claim 11, wherein the processor is configured to select the centralized cache or the at least one neighboring NAP to minimize the delay metrics associated with obtaining the requested content.

14. (canceled)

15. The NAP of claim 11, further comprising:
a second transmitter configured to communicate a message to the selected centralized cache or the at least one neighboring NAP, wherein the message includes a content identifier associated with the requested content; and
a second receiver configured to receive the content associated with the content identifier from the selected centralized cache or the at least one neighboring NAP.

16. The NAP of claim 11, wherein one of the determined delay metrics is an air interface latency associated with transmitting and receiving information over the air interface, wherein the processor is further configured to:
determine an interface latency budget based on the determined delay metrics; and
adjust at least one air interface parameter to optimize the air interface latency.

17. The NAP of claim 16, wherein the at least one air interface parameter is at least one of a modulation and coding scheme (MCS), transmission power, error correction coding, or a quality of service parameter.

18. The NAP of claim 11, wherein the processor is further configured to select at least one neighboring NAP to provide the requested content to the WTRU in a coordinated manner with the NAP.

19. The NAP of claim 18, wherein the second receiver is configured to receive from the centralized cache or the selected at least one neighbor NAP a portion of the requested content, and the transmitter is configured to transmit the portion of the requested content to the WTRU in a coordinated manner with the selected at least one neighbor NAP.

20. (canceled)
